(19) United States
(12) Patent Application Publication
(10) Pub. No.: US 2026/0104299 A1
(43) Pub. Date: Apr. 16, 2026

(54) KINGPIN FOR A FIFTH-WHEEL COUPLING, FIFTH-WHEEL COUPLING WITH KINGPIN, AND UTILITY VEHICLE THEREWITH

(71) Applicant: TRAILER DYNAMICS GMBH, Eschweiler (DE)

(72) Inventors: Abdullah JABER, Aachen (DE); Jakob MUSTAFA, Herzogenrath (DE)

(73) Assignee: TRAILER DYNAMICS GMBH, Eschweiler (DE)

(21) Appl. No.: 19/111,811

(22) PCT Filed: Sep. 15, 2022
(86) PCT No.: PCT/EP2023/074211

§ 371 Date: Mar. 14, 2025

(30) Foreign Application Priority Data
Sep. 15, 2022 (DE) 10 2022 123 659.5

(51) Int. Cl. G01L 1/14; B62D 53/08

(52) U.S. Cl. CPC G01L 1/142; B62D 53/0842

(57) ABSTRACT

The invention relates to a kingpin (10) for a fifth-wheel coupling of a utility vehicle, with a journal shaft (3) which extends along a centre axis (M) and has a journal head (2) at its lower end, wherein the journal shaft (3) has a fastening flange (4) at its upper end remote from the journal head (2), and with a receiving flange (5) which is placed onto the upper end of the journal shaft (3) and is fixed to the fastening flange (4). According to the invention, a measuring device for detecting driving-dynamic reaction forces is provided, wherein the measuring device is arranged in a cavity (15) which is formed in the fixed state between the receiving flange (5) and the upper end of the journal shaft (3).

The invention relates to a kingpin for a fifth-wheel coupling of a utility vehicle in accordance with the preamble of claim 1, to a fifth-wheel coupling having such a kingpin as claimed in claim 14, and to a utility vehicle therewith as claimed in claim 15.

Fifth-wheel couplings are used to couple a semitrailer (referred to as a trailer below) to a semitrailer tractor. Typically, a main plate with a fifth-wheel coupling is mounted on the tractor, into which a kingpin (also referred to as a kingbolt or semitrailer kingpin) mounted on the trailer can be inserted and secured. Via the kingpin and the fifth-wheel coupling, all the loads associated with driving dynamics are then transmitted from the tractor to the trailer and vice versa.

Kingpins for fifth-wheel couplings generally have a pin shaft with a pin head. At the opposite end, the pin shaft usually has a fastening flange, by means of which it is fixed mechanically on a body or on a chassis of a trailer via fastening screws. For mechanical reinforcement and attachment, a mounting flange is usually provided between the chassis of the trailer and the kingpin, via which the kingpin is attached to the chassis of the trailer.

In the prior art, various ways of measurement for determining mechanical reaction forces on the fifth-wheel coupling are proposed. The measurement of reaction forces associated with driving dynamics may be highly significant, for example, in the context of an auxiliary drive axle of the trailer. It is thereby possible to obtain data independently of drive signals of the tractor in order, by means of this data, to operate the auxiliary drive axle of the trailer so as to provide assistance.

Thus, for example, there is a proposal in the prior art for reaction forces acting on the fifth-wheel coupling to be detected directly via the trailer-side kingpin or via the pin shaft in order to infer therefrom the driving behavior of the tractor. Alternatively, there have been proposals for solutions according to which strain gages are positioned directly in the fastening screws. Given a knowledge of whether the tractor is in the process of exerting a braking, pulling or direction-changing effect on the trailer, the auxiliary drive axle can be operated in driving or braking mode. Among the sensors used to detect the forces in the prior art are strain gages, load cells, measuring shims and piezoelectric sensors.

In the variant involving measuring shims, these are installed in the screwed joint between the kingpin and the trailer and in this way measure the clamping forces of the screws. Since the screws are arranged in a manner distributed in the circumferential direction around the kingpin or around the fastening flange, it is possible to infer from the tensile and compressive forces in the measuring shims the forces acting on the kingpin.

However, the installation fittings of these sensors have proven to be complicated to install and maintain in the prior art. Moreover, the pin shaft of the kingpin is subject to severe dynamic loads in use as intended, and therefore the durability of measuring devices which are arranged directly on the pin shaft or in the vicinity is considerably reduced. In addition, direct attachment of the measuring device to the pin is inexpedient in respect of installation space considerations.

Furthermore, strain gages, for example, have proven fundamentally too temperature-sensitive for measuring reaction forces on the kingpin and have excessive scatter in their measured value ranges. In addition, it is not possible to implement differential measurement methods by positioning strain gages within the fastening screws.

It is therefore an object of the present invention to overcome the disadvantages of the prior art and to provide a solution by means of which it is possible to carry out measurement on the kingpin or on the fifth-wheel coupling in a simple manner, at low cost and with easy installation, especially also for maintenance. In addition, the solution should allow measurement in a manner that is insensitive to disturbances. The kingpin or the pin shaft should be replaceable without much effort and without compromising the device for (force) measurement. The solution should be suitable, in particular, for use in the utility vehicle sector and for tractor-trailers with auxiliary drives on the trailer and, in general, with trailer couplings between two vehicles.

The main features of the invention are specified in the characterizing part of claim 1 and claims 14 and 15. Refinements form the subject matter of claims 2 to 13.

In the case of a kingpin for a fifth-wheel coupling of a utility vehicle, with a pin shaft which extends along a central axis and has a pin head at its lower end, wherein the pin shaft has a fastening flange at its upper end remote from the pin head, and with a mounting flange, which is placed on the upper end of the pin shaft and is fixed on the fastening flange, a measuring device for detecting reaction forces associated with driving dynamics is provided according to the invention, wherein the measuring device is arranged in a cavity which, in the fixed state, is formed between the mounting flange and the upper end of the pin shaft.

On account of the spatial and, above all, mechanical separation according to the invention of the measuring device from the pin shaft, said shaft is subjected to significantly lower forces associated with driving dynamics. By virtue of the fact that the measuring device is arranged in a cavity between the mounting flange and the upper end of the pin shaft, it is protected in an effective manner from environmental influences and from severe mechanical loads. Furthermore, the measuring device does not have to be replaced or rewired when replacing a worn kingpin. Calibration of the measuring device for matching to the new kingpin is sufficient.

The measuring device according to the invention is preferably designed primarily to determine reaction forces associated with driving dynamics that act radially with respect to the central axis of the pin shaft and which result in the region of the kingpin or in the region of the fifth-wheel coupling on account of the driving behavior of the semitrailer tractor. During the action of these radial forces, it is especially the distances between the mounting flange and the upper end of the pin shaft that change on account of mechanical deformations. The measuring device is preferably designed to measure these distance changes and to determine the radial reaction forces on the basis of the measured data.

By virtue of the provision according to the invention of the measuring device in the cavity between the mounting flange and the upper end of the pin shaft, distance changes between the mounting flange and the upper end of the pin shaft that are directly related to the acting radial forces can advantageously be detected. At the same time, the measuring device and the electronic connection and wiring that are preferably associated therewith are thereby very largely protected from external environmental influences. Precisely in the lower region of the trailer or chassis, high humidity and temperature conditions may prevail, for which reason the sensitive measuring device would otherwise be exposed to powerful effects. The cavity is preferably of disk-shaped or substantially cylindrical design, wherein, in particular, the cavity is of dish-shaped design. This measure additionally supports precise distance measurement because, by virtue of the principle involved, the disk or dish shape does not have an excessive axial extent along the central axis of the kingpin. Otherwise, the distance between the mounting flange and the upper end of the pin shaft would possibly be too large for the measurement under consideration. It is important in this context that even relatively small deformations or distance changes can be detected by the measuring device.

The mounting flange is attached as a separate component at the upper end of the pin shaft. The upper end of the pin shaft is preferably flanged to the mounting flange via the fastening flange. In this case, the fastening flange of the pin shaft can preferably be fixed releasably to the mounting flange via fixing means. In this case, the fixing means are preferably designed as screws, wherein the screws are, in particular, threaded screws which, in the case of a 2 inch kingpin according to ECE Directive R55-01, fix the pin shaft on the mounting flange and satisfy DIN 74080 and ISO 337 standards, wherein, in the case of a 3.5 inch kingpin according to ECE Directive R55-01, the threaded screws fix the pin shaft on the mounting flange and satisfy DIN 74083 and ISO 4086 standards. At the level of the fixing means, the mounting flange is preferably in full surface contact with the fastening flange in the circumferential direction and is fixed in such a way that the cavity is bordered by the flanged-on surface.

The mounting flange acts primarily as an additional fastening or reinforcing element between the trailer and the pin shaft. The mounting flange can preferably serve simultaneously as a mounting element for the measuring device. In this context, one preferred embodiment of the invention envisages that the mounting flange has a dish base, wherein the dish base has an underside, facing the cavity, for receiving the measuring device. In this case, the dish base can be arranged parallel to the upper end of the pin shaft. As a further preference, the mounting flange can be of substantially dish-shaped design, wherein the dish base of the mounting flange can be, in particular, disk-shaped. It is furthermore preferred that the underside of the dish base is of flat design. By virtue of these configurations, a level and uniform supporting surface for the measuring device is formed on the underside of the dish base, and therefore the measuring device can rest against and be fastened to the underside of the chassis over its full surface, for example. The disk-shaped design of the dish base furthermore supports the design of the cavity for the reception of the measuring device.

It is furthermore preferred that the dish base has an upper side, facing away from the cavity, for fixing the mounting flange. In this case, the upper side of the dish base can preferably be connected in a materially integral manner to a chassis of the trailer. In this case, the upper side and the underside of the dish base can preferably each be of flat design. As a further preference, the upper side of the dish base is arranged parallel to an underside of the chassis. In this case, the underside of the chassis is preferably arranged parallel to a roadway. To enable the upper side to be fixed securely to the underside of the chassis, the underside of the chassis can preferably be of flat design. As a result, a level and uniform supporting surface for the upper side of the dish base is formed on the underside of the chassis, and therefore the dish base can rest against and be connected, e.g. in a materially integral manner, to the underside of the chassis over its full surface.

According to another preferred embodiment of the invention, the upper end of the pin shaft has an inner end face which faces the cavity, wherein the upper end of the pin shaft has an outer end face which faces the cavity. Both end faces can preferably be of flat design, wherein the end faces can be arranged parallel to the underside of the mounting flange. Inter alia, this measure can support the measurement of the radial reaction forces.

The upper end of the pin shaft preferably has an annular raised portion, which extends in the direction of the dish base, wherein the annular raised portion is arranged between the inner end face and the outer end face. The annular raised portion shortens the distance between the underside of the dish base and the upper end of the pin shaft. It would thereby be possible, for example, to increase the sensitivity of the measuring device in order to detect even relatively small distance changes. The annular raised portion advantageously offers an annular surface which could serve as a corresponding counter-surface to the measuring device in the context of measurement, for example. In this case, it is preferred that the annular raised portion is of flat design on its end face facing the underside of the dish base. This measure leads to an additional improvement in the measurement accuracy of the measuring device if the annular raised portion is used as a corresponding measurement counter-surface. Measurement would be effectively disturbed by irregularities on the end face of the annular raised portion. In this case, the disturbance factors would have to be taken into account accordingly during the evaluation of the measured data. In contrast, a flat surface in accordance with the embodiment described supports and improves the measuring process significantly. Here, the annular shape has a particularly advantageous effect because corresponding measuring sensors can be positioned along the, preferably continuous, annular surface.

According to another variant embodiment, the measuring device is of substantially disk-shaped design, wherein the measuring device has a cross shape. As a result, the measuring device can rest against and be fixed securely on a suitable location, e.g. over its full surface. By virtue of the disk shape and the alignment of the measuring device, the above-described measurement of radially acting forces is supported, on the one hand, and the measuring device is as a result more compact, on the other hand. This in turn has an advantageous effect on aspects relating to installation space. As a result, the measuring device fits into the cavity between the underside of the dish base and the upper end of the pin shaft, said cavity being kept small by virtue of the principle involved. Furthermore, the disk-shaped design additionally supports differential measurement. In this case, the cross shape of the measuring device can be used, for example, to specify the corresponding directions of the radially acting reaction forces to be determined. Furthermore, by virtue of this special arrangement, an additional improvement in measurement accuracy can advantageously be obtained. It is furthermore preferred here that the measuring device is of symmetrical design. Inter alia, this simplifies the work involved in manufacture and simultaneously lowers manufacturing costs.

The measuring device is preferably arranged in a manner centered with respect to the central axis of the pin shaft, wherein the measuring device is designed to measure distance changes with respect to the upper end of the pin shaft. The measuring device preferably comprises at least two distance sensors, as a further preference at least four distance sensors, for measuring distance changes between the dish base and the upper end of the pin shaft. It is preferred here that the individual distance sensors of the measuring device extend radially with respect to the central axis. Contactless distance sensors are preferably provided. Physical wear during measurement is thereby avoided. Contactless distance sensors are suitable especially for rapid measurements. Furthermore, distance sensors of capacitive design are, for example, advantageously insensitive to magnetic fields and can therefore be employed without problems on electrified trailers.

According to another preferred embodiment of the invention, it is envisaged that the measuring device is arranged directly on the underside of the dish base, wherein the measuring device is positioned opposite to the inner end face and to the annular raised portion. In this case, it is furthermore preferred that the measuring device, the underside of the dish base, the inner end face and the annular raised portion are each arranged in a manner centered with respect to the central axis. Consequently, “opposite” entails a coaxial or concentric arrangement of the measuring device, wherein the measuring device is arranged spaced apart from the inner end face and the annular raised portion, axially with respect to the central axis. The direct arrangement and fixing of the measuring device on the underside of the dish base additionally supports the mechanical decoupling of the measuring device from the pin shaft. At the same time, the measuring device is thereby decoupled from vibrations that may occur, for example, at the upper end of the pin shaft. In this case, the entire wiring and signal transmission system of the measuring device is preferably likewise designed to be separate from the pin shaft. In this case, the entire wiring and signal transmission system preferably leads in the direction of the underside of the trailer or in the direction of the chassis. This facilitates the attachment of the measuring device and additionally protects the wiring and electronics from external influences and loads.

As a further preference, the measuring device is arranged plane-parallel to the underside of the dish base and plane-parallel to the inner end face and to the annular raised portion. As a result, the measuring device can rest against and be fixed on the underside of the dish base over its full surface. In addition, this creates a sufficient distance from the upper end of the pin shaft, with the result that distance measurement between the measuring device on the underside of the dish base and the annular raised portion can preferably be performed. The plane-parallelism between the measuring device, the underside of the dish-shaped mounting flange and the upper end of the pin shaft considerably improves measurement accuracy. At the same time, the implementation of differential measurement is thereby supported. The plane-parallel arrangement furthermore ensures that it is primarily the initially described reaction forces acting radially with respect to the central axis that are determined.

In particular, the measuring device is preferably designed to measure distance changes in relation to the annular raised portion. In this case, it is particularly preferred that the distance sensors of the measuring device are arranged opposite the annular raised portion, wherein the distance sensors are arranged parallel to the annular raised portion. In this case, it is preferred that the radial extent of the individual distance sensors corresponds to a radial extent of the annular raised portion. This ensures that the sensor surfaces of the measuring device correspond to the counter-surface of the annular raised portion. In this case, the measuring device preferably has signal processing electronics, wherein the signal processing electronics of the measuring device are arranged in a manner centered with respect to the central axis of the pin shaft, and wherein the signal processing electronics are surrounded by the individual distance sensors radially with respect to the central axis. This is advantageous for reasons to do with installation space and additionally protects the electronics. The signal transmission and wiring system routing and the connection of the electronics is thereby likewise greatly simplified. In addition to data transfer and processing, the signal processing electronics can furthermore be used to digitize measurement variables and to coordinate the corresponding signal transmission. The signals can be fed to a corresponding CAN network for further processing and/or evaluation and can form corresponding parameters for open-loop and closed-loop control circuits.

As a preferred option, at least one distance sensor is aligned radially with respect to the central axis and in the vehicle longitudinal direction, wherein at least one further distance sensor is aligned radially with respect to the central axis and in the vehicle transverse direction. As a further preference, at least two distance sensors are aligned radially with respect to the central axis and in the vehicle longitudinal direction, wherein at least two further distance sensors are aligned radially with respect to the central axis and in the vehicle transverse direction. In this case, it is particularly preferred that the distance sensors aligned in the vehicle longitudinal direction extend in opposite directions radially with respect to the central axis and in the vehicle longitudinal direction, whereas the distance sensors aligned in the vehicle transverse direction extend in opposite directions radially with respect to the central axis and in the vehicle transverse direction. This special arrangement of the measuring device and of the distance sensors has proven particularly advantageous because it enables the desired radial forces to be determined primarily. In this case, radial forces which act in the vehicle longitudinal direction (longitudinal force components) and in the vehicle transverse direction (lateral force components) are preferentially determined by means of the measuring device. In the context of the invention, “lateral” and “longitudinal” refer primarily to all reaction forces acting in a longitudinally dynamic and transversely dynamic way. These reaction forces act radially in relation to the central axis of the pin shaft and are the result, in the region of the fifth-wheel coupling or in the region of the kingpin, of the relative accelerations and/or deceleration and/or direction changes between the tractor and the trailer. It may have considerable advantages, precisely for the purpose of controlling a supporting drive of the trailer, if only longitudinally and transversely dynamic radial forces are measured and axial or vertical force components as well as all other force components are very largely eliminated even at the measurement stage or can be subsequently excluded or offset for purposes of open-loop and closed-loop control of the supporting drive.

Furthermore, the special arrangement of the distance sensors ensures the implementation of a differential measurement method. It is thereby possible, for example, during the measurement process to perform differential evaluation of in each case two opposite distance sensors described above. Mechanical common-mode interference or temperature-related deviations that occur during the measurement of the distance changes are thereby compensated, in particular. Here, the value (output signal) to be transferred for further evaluation and processing can correspond to the difference between these two potentials. The major advantage of differential measurement is in its significantly reduced susceptibility to disturbances. This significantly improves the sensitivity of the measuring device to disturbances. Each individual signal of the differential transmission is equally susceptible to disturbances and can take on a “distorted” value in accordance with the disturbance. The difference between the two disturbed signals corresponds to the signal to be transmitted while itself being unaffected since both signals are distorted to precisely the same extent. This type of differential measurement can be recommended especially for the application of the invention to trailers with auxiliary drives.

According to another preferred embodiment, the invention envisages that the measuring device is designed as a capacitive sensor unit, wherein the individual distance sensors of the capacitive sensor unit are formed by capacitive sensor surfaces. Capacitive sensors are designed for contactless travel measurements, distance measurements and position measuring tasks but are also employed to measure the thickness of various materials. The capacitive distance sensor and the (movable) counter-surface form an electrical capacitor, the distance between which determines the capacitance. The counter-surface or counter-surfaces can preferably be formed by the upper end of the pin shaft and/or the underside of the dish base. Thanks to their high signal stability and resolution, capacitive sensors are used for measurement tasks in laboratories and in industry. In this context, capacitive distance sensors advantageously offer very reliable and precise position detection of objects of almost any material, irrespective of shininess, reflectivity, color and surface characteristics. Moreover, capacitive sensors are distinguished by a long life and can implement completely contactless measurement principles.

The cross shape of the sensor proves to be particularly advantageous in the context of force measurement on the fifth-wheel coupling because the “cross tips” of the cross shape can be aligned on the dish-shaped mounting flange in the direction of the radial force components to be measured. The capacitive sensor unit can preferably be of symmetrical design, thus enabling the cross shape to be generated by four identical recesses, for example. This simplifies manufacture and lowers the production costs of the measuring device. At the same time, a radial measurement direction or alignment of the capacitive sensor surfaces or distance sensors is thereby ensured. The four capacitive surfaces preferably form the abovementioned “cross tips”. The provision of four capacitive surfaces makes it possible overall to carry out a sufficient number of measurements for complete determination of the radial reaction forces in the vehicle longitudinal and vehicle transverse directions. It is particularly preferred here that at least four capacitive sensor surfaces are provided, which extend radially with respect to the central axis and form a cross shape. Overall, precise and uniform measurement of the reaction forces on the fifth-wheel coupling is thereby supported. In addition, the cross shape can be used to enable additional force components to be determined between two sensor surfaces.

The invention furthermore relates to a fifth-wheel coupling having a kingpin as described above and below, wherein the fifth-wheel coupling comprises a main plate, and wherein the main plate and the fifth-wheel coupling are arranged to receive a kingpin on a semitrailer tractor of a utility vehicle.

The invention furthermore relates to a utility vehicle having a fifth-wheel coupling and a kingpin as described above and below.

According to one alternative embodiment of the invention, further sensors for further segmentation and refinement of the measuring device can be arranged between the at least four distance sensors. This may be useful and advantageous especially if, according to requirements, finer measurements have to be carried out or additional force components situated between the cross tips are to be directly measured.

According to another alternative variant embodiment, it is possible, for example, to place a washer in the cavity to hold the measuring device instead of an annular raised portion, said washer reducing the distance between the underside of the dish base and the upper end of the pin shaft. According to this alternative variant embodiment, the upper end of the pin shaft and the underside of the dish base can advantageously be of flat design.

According to another alternative variant embodiment, the measuring device can be arranged directly on the upper end of the pin shaft. There is a preference here for the entire end face of the upper end of the pin shaft to be of flat design to receive the measuring device. Conversely, the underside of the dish base can accordingly be provided with an annular raised portion which extends in the direction of the upper end of the pin shaft. Inter alia, this simplifies manufacture and saves costs.

According to another alternative embodiment, the signal processing electronics can be formed separately from the measuring device or the distance sensors of the measuring device, for example, thus enabling the signal processing electronics not to be arranged in the cavity but in an outer region.

According to another alternative variant configuration, other types of contactless distance sensors, e.g. magnetic strip sensors, can be used for distance measurement instead of contactless capacitive distance sensors. Other types of sensor and configurations are also conceivable as long as determination of the desired loads associated with driving dynamics is ensured.

Further features, details and advantages of the invention can be derived from the wording of the claims and from the following description of exemplary embodiments with reference to the drawings. In the drawings:

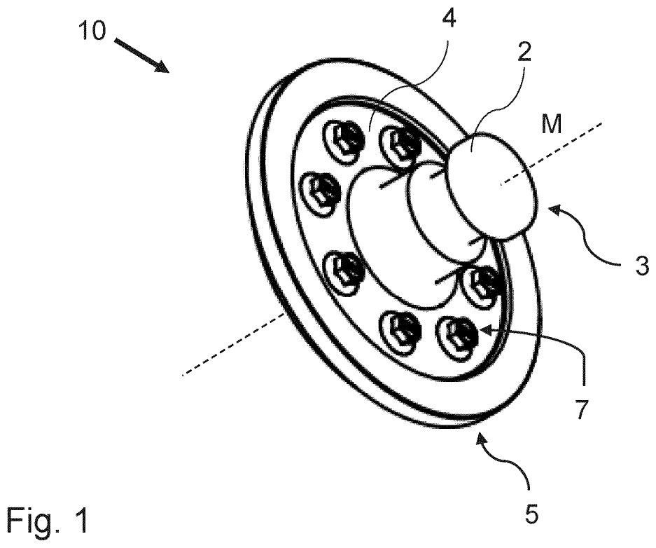

FIG. 1 shows a schematic oblique view of a kingpin according to the invention for coupling a trailer to a fifth-wheel coupling of a tractor;

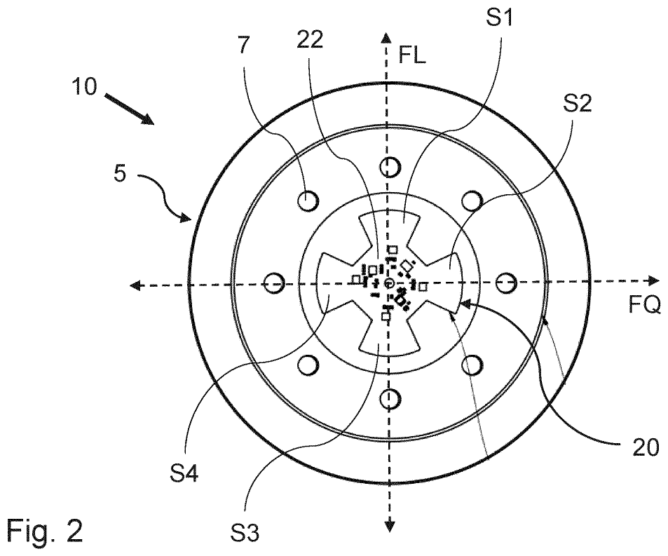

FIG. 2 shows a partial plan view of a kingpin according to the invention and a schematic illustration of the measuring device;

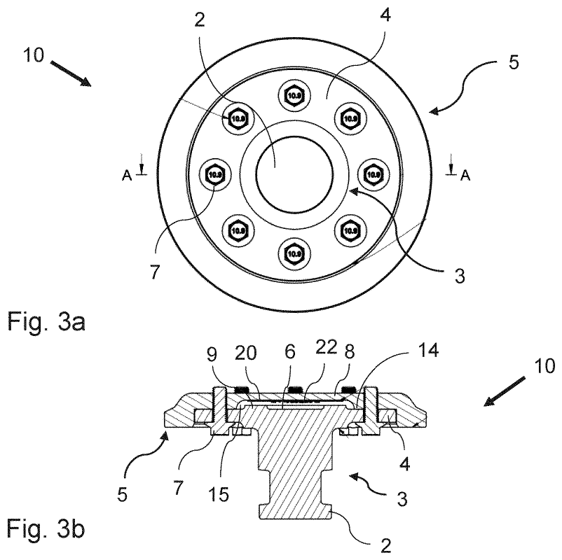

FIG. 3a shows a bottom view of a kingpin according to the invention;

FIG. 3b shows a cross section through a kingpin according to the invention.

FIG. 1 illustrates a kingpin, denoted overall by 10, for a fifth-wheel coupling of a utility vehicle. The kingpin 10 comprises a pin shaft 3, which extends along a central axis M of the kingpin 10. The pin shaft 3 is provided at its lower end with a pin head 2. The lower end of the pin shaft 3 and the pin head 2 are aligned perpendicularly to a roadway (not illustrated) during the coupling process and inserted into the fifth-wheel coupling (not shown) of the tractor, and fixed.

A fastening flange 4 and a dish-shaped mounting flange 5 for fixing the kingpin 10 are arranged at the opposite, upper end of the pin shaft 3, which faces a chassis or an underside of a chassis of a trailer. In this case, the dish-shaped mounting flange 5 is usually pre-installed in a materially integral manner on the chassis of the trailer and can receive and fix the fastening flange 4 of the pin shaft 3. For this purpose, the dish-shaped mounting flange 5 is placed on the upper end of the pin shaft 3 and fixed on the fastening flange 4. To fasten the pin shaft 3 to the dish-shaped mounting flange 5, fixing means are arranged in the region of the fastening flange 4. The fixing means are designed as threaded screws 7 and are arranged around the pin shaft 3 at constant spacings in the circumferential direction.

Additional reference to FIG. 2 makes clear that a measuring device for detecting reaction forces associated with driving dynamics is provided on an upper side of the dish-shaped mounting flange 5, wherein the measuring device is designed as a capacitive sensor unit 20.

In this case, the capacitive sensor unit 20 is of substantially disk-shaped design and has a cross shape. The capacitive sensor unit 20 is arranged directly on the dish-shaped mounting flange 5. The dish-shaped mounting flange 5 does not normally have an opening on its upper side. A cutout is shown in plan view to illustrate the capacitive sensor unit 20.

The capacitive sensor unit 20 furthermore has four distance sensors, which extend radially with respect to the central axis M of the pin shaft 3. The distance sensors are designed as capacitive sensor surfaces S1, S2, S3, S4. Sensors surfaces S1, S3 extend radially with respect to the central axis M and simultaneously in the vehicle longitudinal direction FL. In this case, sensor surfaces S1, S3 extend in opposite directions along the vehicle longitudinal direction FL. Sensors surfaces S2, S4 extend radially with respect to the central axis M and simultaneously in the vehicle transverse direction FQ. In this case, sensor surfaces S2, S4 extend in opposite directions along the vehicle transverse direction FQ.

Furthermore, the capacitive sensor unit 20 has signal processing electronics 22. The signal processing electronics 22 of the capacitive sensor unit 20 are arranged in a manner centered with respect to the central axis M of the pin shaft 3. In this case, the signal processing electronics 22 are surrounded by the individual capacitive sensor surfaces S1, S2, S3, S4 radially with respect to the central axis M.

When viewing FIG. 3a and FIG. 3b together, it can be seen that the dish-shaped mounting flange 5 and the fastening flange 4 are flanged and releasably fixed to one another in such a way that the mounting flange 5 is in full surface contact with the fastening flange 4 in the circumferential direction at the level of the threaded screws 7, with the result that a cavity 15 is bordered by the flanged area.

It can furthermore be seen that the capacitive sensor unit 20 is arranged in the cavity 15. In the fixed state, the cavity 15 is formed between the dish-shaped mounting flange 5 and the upper end of the pin shaft 3. In this case, the cavity 15 is of substantially disk-shaped and, in particular, dish-shaped design.

The dish-shaped mounting flange 5 has a dish base 8, wherein the dish base 8 has an underside, facing the cavity 15, for receiving the capacitive sensor unit 20. The dish base 8 is arranged parallel to the upper end of the pin shaft 3, and the underside of the dish base 8 is of flat design. The capacitive sensor unit 20 is arranged, in particular, directly on the underside of the dish base 8. In this case, the capacitive sensor unit 20 rests over its entire area on the underside of the dish base 8 and is fixed. The capacitive sensor unit 20 is furthermore arranged plane-parallel to the underside of the dish base 8 and plane-parallel to the upper end of the pin shaft 3.

In addition, the dish base 8 of the mounting flange 5 has a flat upper side, facing away from the cavity 15, for fixing the mounting flange 5. The upper side of the dish base 8 is generally connected in a materially integral manner to the chassis of the trailer (not illustrated). In this case, the underside of the chassis is arranged parallel to the roadway.

The upper end of the pin shaft 3 has an inner end face 6 which faces the cavity 15, wherein the upper end of the pin shaft 3 has an outer end face 14 which faces the cavity. Both end faces 6, 14 are of flat design and are arranged in a manner centered with respect to the central axis M. In this case, the end faces 6, 14 are simultaneously arranged parallel to the underside of the dish base 8.

The upper end of the pin shaft 3 furthermore has an annular raised portion 9, which extends in the direction of the dish base 8, wherein the annular raised portion 9 is arranged between the inner end face 6 and the outer end face 14. The capacitive sensor unit 20 is arranged directly on the underside of the dish base 8, wherein the capacitive sensor unit 20 is positioned opposite the inner end face 6 and the annular raised portion 9. The measuring device and the capacitive sensor unit 20, the underside of the dish base 8, the inner and outer end faces 6, 14 and the annular raised portion 9 are all arranged in a manner centered with respect to the central axis M.

The annular raised portion 9 advantageously provides an annular surface as a measurement counter-surface opposite the capacitive sensor unit 20 or capacitive sensor surfaces S1, S2, S3, S4. In this case, the annular raised portion 9 is of flat design on its annular surface facing the underside of the dish base 9.

The capacitive sensor unit 20 is designed to measure distance changes in relation to the upper end of the pin shaft 3 in order to enable reaction forces acting radially with respect to the central axis to be determined from the measured data. In particular, the capacitive sensor unit 20 is designed to measure distance changes in relation to the annular raised portion 9. As can be seen, in particular, from FIG. 3, the radial extent of the individual capacitive sensor surfaces S1, S2, S3, S4 corresponds to a radial extent of the annular raised portion 9.

The invention is not restricted to one of the above-described embodiments but can be modified in a variety of ways. Thus, for example, more or fewer sensor positions can be provided on the capacitive sensor unit.

The kingpin according to the invention can be employed generally to measure reaction forces on a coupling element between two vehicles. Primarily, the invention relates to the measurement of reaction forces that act on a fifth-wheel coupling or on the kingpin of a trailer. In this case, measurement is used for the open-loop and closed-loop control of a supporting drive of the trailer. The invention can furthermore be useful for the closed-loop control of other types of drives in the trailer, e.g. for the closed-loop control of hydraulic drive axles. Alternatively, it may be expedient to employ the measuring device at separate points in order to measure drag forces.

All the features and advantages which emerge from the claims, the description and the drawing, including design details, spatial arrangements and method steps, may be essential to the invention either per se or in a wide variety of combinations.

### LIST OF REFERENCE SIGNS

M central axis of kingpin
FL vehicle longitudinal direction
FQ vehicle transverse direction
A-A cross section plane
S1 capacitive sensor surface
S2 capacitive sensor surface
S3 capacitive sensor surface
S4 capacitive sensor surface
2 pin head
3 pin shaft
4 fastening flange
5 mounting flange
6 inner end face
7 screws
8 dish base
9 annular raised portion
10 kingpin
14 outer end face
15 cavity
20 capacitive sensor unit
22 signal processing electronics

1. A kingpin (10) for a fifth-wheel coupling of a utility vehicle, with a pin shaft (3) which extends along a central axis (M) and has a pin head (2) at its lower end, wherein the pin shaft (3) has a fastening flange (4) at its upper end remote from the pin head (2), and with a mounting flange (5), which is placed on the upper end of the pin shaft (3) and is fixed on the fastening flange (4), characterized in that a measuring device for detecting reaction forces associated with driving dynamics is provided, wherein the measuring device is arranged in a cavity (15) which, in the fixed state, is formed between the mounting flange (5) and the upper end of the pin shaft (3).

2. The kingpin as claimed in claim 1, characterized in that the measuring device has a cross shape, wherein the measuring device is of substantially disk-shaped design.

3. The kingpin as claimed in claim 1, characterized in that the upper end of the pin shaft (3) has an inner end face (6) which faces the cavity (15), wherein the upper end of the pin shaft (3) has an outer end face (14) which faces the cavity (15).

4. The kingpin as claimed in claim 1, characterized in that the upper end of the pin shaft (3) has an annular raised portion (9).

5. The kingpin as claimed in claim 1, characterized in that the mounting flange (5) has a dish base (8), wherein the dish base (8) has an underside, facing the cavity (15), for receiving the measuring device.

6. The kingpin as claimed in claim 5, characterized in that the measuring device is arranged plane-parallel to the underside of the dish base (8) and plane-parallel to the upper end of the pin shaft (3).

7. The kingpin as claimed in claim 5, characterized in that the measuring device is arranged and fixed directly on the underside of the dish base (8), wherein the measuring device is positioned opposite to the inner end face (6) and to the annular raised portion (9).

8. The kingpin as claimed in claim 1, characterized in that the measuring device is designed to measure distance changes with respect to the upper end of the pin shaft (3), wherein the measuring device comprises at least two distance sensors, preferably at least four distance sensors.

9. The kingpin as claimed in claim 8, characterized in that the measuring device has signal processing electronics (22), wherein the signal processing electronics are arranged in a manner centered with respect to the central axis (M) of the pin shaft (3), and wherein the signal processing electronics (22) are surrounded by the individual distance sensors radially with respect to the central axis (M).

10. The kingpin as claimed in claim 8, characterized in that the measuring device is arranged in a manner centered with respect to the central axis (M) of the pin shaft (3), wherein the individual distance sensors of the measuring device extend radially with respect to the central axis (M).

11. The kingpin as claimed in claim 8, characterized in that at least one distance sensor is aligned radially with respect to the central axis (M) and in the vehicle longitudinal direction (FL), wherein at least one further distance sensor is aligned radially with respect to the central axis (M) and in the vehicle transverse direction (FQ).

12. The kingpin as claimed in claim 8, characterized in that at least two distance sensors are aligned radially with respect to the central axis (M) and in the vehicle longitudinal direction (FL), wherein at least two further distance sensors are aligned radially with respect to the central axis (M) and in the vehicle transverse direction (FQ).

13. The kingpin as claimed in claim 8, characterized in that the measuring device is designed as a capacitive sensor unit (20), wherein the individual distance sensors of the capacitive sensor unit (20) are formed by capacitive sensor surfaces (S1, S2, S3, S4).

14. A fifth-wheel coupling having a kingpin as claimed in claim 1, characterized in that the fifth-wheel coupling comprises a main plate, wherein the main plate and the fifth-wheel coupling are arranged to receive a kingpin on a semitrailer tractor of a utility vehicle.

15. A utility vehicle having a fifth-wheel coupling and a kingpin as claimed in claim 14.
